(19) United States
(12) Patent Application Publication
(10) Pub. No.: US 2010/0106450 A1
(43) Pub. Date: Apr. 29, 2010

(54) METHOD AND APPARATUS FOR SENSING MEAL ACTIVITY USING PRESSURE SENSOR

(75) Inventors: Ho Youl JUNG, Daejeon (KR); Jae Won JANG, Daejeon (KR); Sa Kwang SONG, Daejeon (KR); Min Ho KIM, Daejeon (KR); Seon Hee PARK, Daejeon (KR); Soo Jun PARK, Seoul (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/605,789

(22) Filed: Oct. 26, 2009

(30) Foreign Application Priority Data
Oct. 27, 2008 (KR) 10-2008-0105337

(51) Int. Cl. G06F 15/00

(52) U.S. Cl. 702/138; 702/188

(57) ABSTRACT

There is provided a method and apparatus for sensing a meal activity among the various activities of daily life using pressure sensors. A meal activity sensing apparatus collects sensor data detected through a plurality of pressure sensors installed in a smart meal mat, filters the collected sensor data, measures a pressure variance by using the filtered sensor data, determines whether a meal activity has taken place by comparing the measured pressure variance with a preset threshold value, and transmits meal activity information associated with the meal activity to an information processor communicating with the smart meal mat via radio frequency. Since this provides an advantage of more accurate detection of the meal activity, it can be useful in care services for eldercare facilities and for elderly individuals living alone, and further, in the efficient observance of an individual's daily meal patterns.

### CROSS-REFERENCE TO RELATED APPLICATIONS

This application claims the priority of Korean Patent Application No. 10-2008-0105337 filed on Oct. 27, 2008, in the Korean Intellectual Property Office, the disclosure of which is incorporated herein by reference.

### BACKGROUND OF THE INVENTION

1. Field of the Invention

The present invention relates to a method and apparatus for sensing a meal activity among the various activities of daily life, and more particularly, to a method and apparatus for sensing a meal activity using pressure sensors.

2. Description of the Related Art

Rapid societal aging has stimulated interest in elderly care needs. In line with this stimulation, the demand for elderly care services is increasing. Such demand encourages the development of various technologies for elderly care services that monitor the daily activities of elderly individuals, analyze data related to the specific activities, and manage them remotely.

In general, daily activities are the essential things in daily living such as meal and sleep activities, which are limited to the definition of a dictionary. In particular, meal activity has great importance, so it needs to be carefully managed.

In order to determine whether or not a meal has actually been eaten, a sensor detecting blood sugar levels may be transplanted into a user's body. This would make it possible to accurately detect meal activity. However, this is not easily implemented due to technological and ethical considerations.

Therefore, existing technologies related to detecting a meal activity mainly employ a method of automatically detecting whether contact between a user and a set of tableware, cookware, or the like has occurred. However, this method lacks accuracy and thus has difficulties in sensing an actual meal activity.

### SUMMARY OF THE INVENTION

An aspect of the present invention provides a method and apparatus for sensing a meal activity by installing pressure sensors in a meal mat and measuring a pressure variance in the installed pressure sensors so as to more accurately detect whether the meal activity has taken place, even though the invention does not suggest detecting whether a meal has actually been eaten (whether food has passed through an esophagus).

According to an aspect of the present invention, there is provided a method of sensing a meal activity using pressure sensors, the method including: collecting sensor data from a plurality of pressure sensors installed in a smart meal mat; measuring a pressure variance by using the collected sensor data; determining whether a meal activity has taken place by comparing the measured pressure variance with a preset threshold value; and transmitting meal activity information associated with the meal activity.

According to another aspect of the present invention, there is provided a meal activity sensing apparatus using pressure sensors, including a sensor data collector collecting sensor data detected through a plurality of pressure sensors installed in a smart meal mat; a controller measuring a pressure variance by using the collected sensor data and determining whether a meal activity has taken place by comparing the measured pressure variance with a preset threshold value; and a data transmitter/receiver transmitting meal activity information associated with the meal activity to an information processor communicating with the smart meal mat via radio frequency.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates a configuration for a meal activity sensing system using pressure sensors according to an exemplary embodiment of the present invention;

FIG. 2 illustrates the installation of pressure sensors in a smart meal mat according to an exemplary embodiment of the present invention;

FIG. 3 illustrates a configuration for a meal activity sensing apparatus according to an exemplary embodiment of the present invention; and

FIG. 4 illustrates a method of sensing a meal activity using pressure sensors in a meal activity sensing apparatus according to an exemplary embodiment of the present invention.

### DETAILED DESCRIPTION OF THE PREFERRED EMBODIMENT

Exemplary embodiments of the present invention will now be described in detail with reference to the accompanying drawings. Moreover, detailed descriptions related to well-known functions or configurations will be ruled out in order not to unnecessarily obscure subject matters of the present invention.

In exemplary embodiments of the present invention, a pressure sensor is used for sensing a meal activity among the activities of daily living. Such a pressure sensor is used as a module sensing daily activities in a manner that measures a pressure amount applied to each sensor. This is mainly utilized for the purpose of sensing an interaction between a human and an object.

According to exemplary embodiments of the present invention, in order to sense a meal activity, pressure sensors are installed in a meal mat upon which a set of tableware is disposed, and measure a difference in pressure values (pressure variance) (Δpₜ=pₜ−pₜ_{_{—}}₁) that are calculated on the basis of the pressures applied by utensils such as spoons, chopsticks, knives, and forks associated with the meal activity.

The reason for using the pressure variance is that when pressure applied to the meal mat is made by other objects such as books, a probability of having a low pressure variance may increase.

By the use of these pressure sensors, a method and apparatus for sensing a meal activity according to exemplary embodiments of the present invention will be described in detail. The configurations for a meal activity sensing system and a meal activity sensing apparatus included therein will now be described in detail with reference to the accompanying drawings.

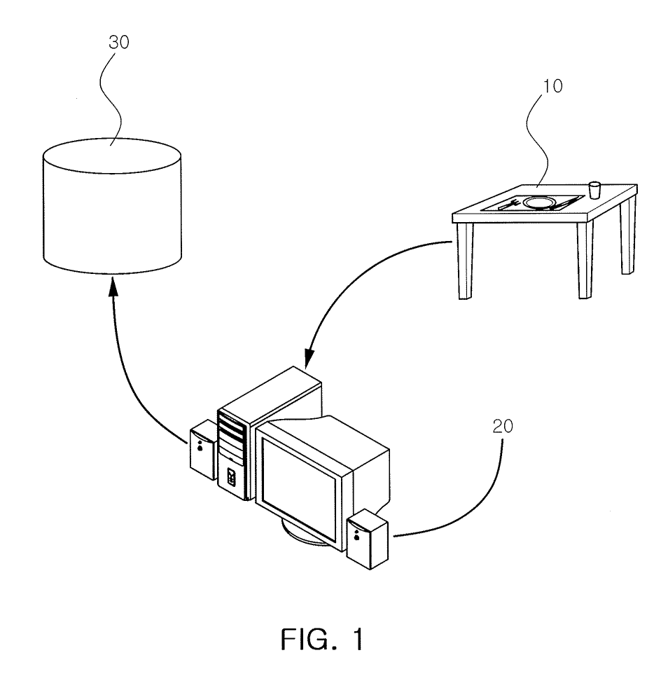

FIG. 1 illustrates a configuration for a meal activity sensing system using pressure sensors according to an exemplary embodiment of the present invention.

Referring to FIG. 1, a meal activity sensing system includes a smart meal mat 10, an information processor 20, and a daily activity database 30.

The smart meal mat 10 is installed with a plurality of pressure sensors, thereby constituting a meal activity sensing apparatus 100 that detects whether a meal activity has occurred. The meal activity sensing apparatus 100 measures a pressure variance by using sensor data detected through the plurality of pressure sensors when pressure is applied by a set of tableware, determines whether a meal activity has occurred by using the measured pressure variance, and transmits meal activity information associated with the determined meal activity to the information processor 20 via radio frequency. A concrete configuration of the meal activity sensing apparatus 100 will be described below in detail.

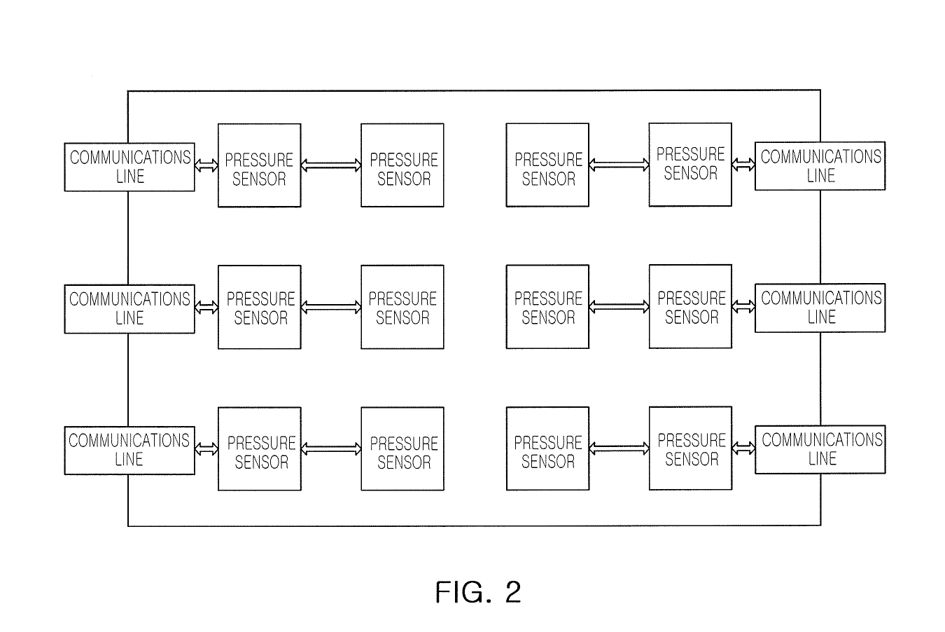

An exemplary embodiment of the arrangement between the pressure sensors installed in the smart meal mat 10 and communications lines is illustrated in FIG. 2. The pressure sensors may use a force sensing resistor (FSR). This embodiment is intended to explain the concept of the invention, but the invention is not limited thereto.

Also, the number of pressure sensors and the installation positions thereof may be variable according to the size of the smart meal mat 10 and the footprint of the tableware. Each pressure sensor may be connected to its neighboring sensor by a wire that can be charged with an electrical current. The end of the connection may be configured as a communications line entering a communications module for transmitting information to the information processor 20. The outer cover of the smart meal mat 10 should be constructed with heatproofing and waterproofing taken into account.

The information processor 20 may be a computer or a portable terminal. It provides observers or family members with information related to an elderly individual's meal activity according to whether the meal activity has occurred by using the information transmitted from the smart meal mat 10. Also, the information processor 20 records meal activity information such as user information U_{id}, meal start time tₛ, and meal end time tₑ in the daily activity database 30.

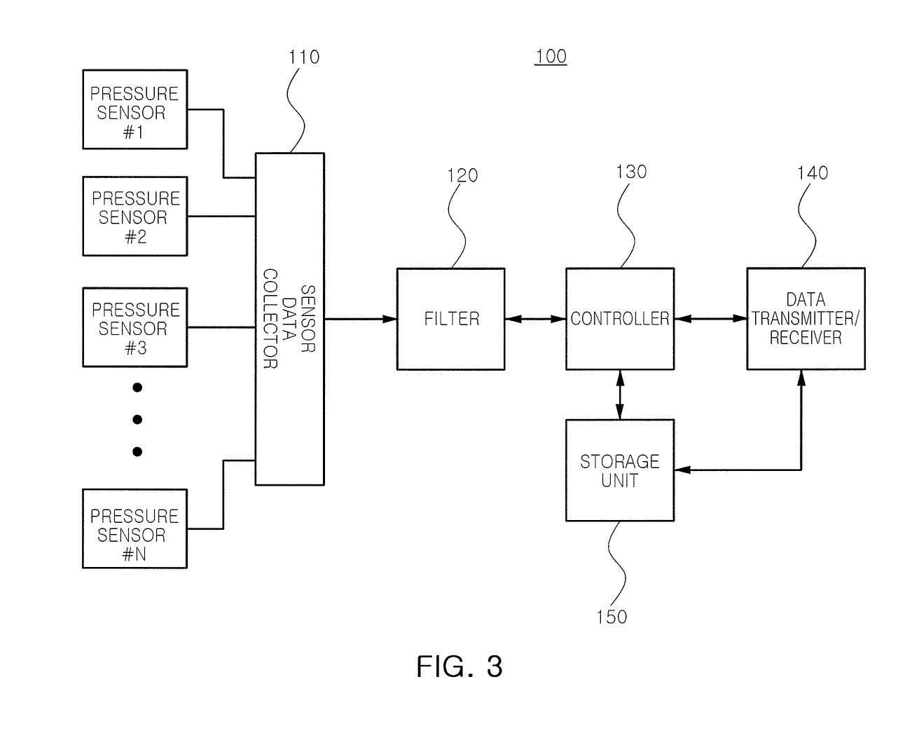

FIG. 3 illustrates a configuration for a meal activity sensing apparatus according to an exemplary embodiment of the present invention.

The meal activity sensing apparatus 100 may include a sensor data collector 110, a filter 120, a controller 130, a data transmitter/receiver 140, and a storage unit 150.

The sensor data collector 110 collects sensor data from the pressure sensors installed in the smart meal mat 10 and transmits the collected sensor data to the filter 120.

The filter 120 filters the sensor data transmitted from the sensor data collector 110. The filter 120 sets a fundamental threshold value which is a minimum value that can be recognized as pressure being applied in order to perform the filtering and compensates for an initializing value of multiple sensor data in order to uniformly maintain the initializing values of the plurality of pressure sensors.

The controller 130 measures a pressure variance by using the filtered sensor data transmitted from the filter 120, determines whether or not a meal activity has taken place by comparing the measured pressure variance with a preset threshold value, transmits the information associated with the meal activity to the storage unit 150, and controls the storage unit 150 to store that information. Concrete operations will be described below in detail. Also, the controller 130 controls a filtering operation. Furthermore, when it is determined that the meal activity has taken place as a result of the above comparison, the controller 130 controls the sensor data collector 110 to collect subsequent sensor data.

The data transmitter/receiver 140 transmits the information associated with the determined meal activity, which is transmitted from the controller 130, to the information processor 20 via radio frequency, receives preset meal activity information such as user information U_{id}, meal start time tₛ, and meal end time tₑ from the information processor 20, and then transmits the preset meal activity information to the controller 130.

A method of sensing a meal activity using pressure sensors in the meal activity sensing apparatus having the aforementioned configuration will now be described with reference to the accompanying drawings.

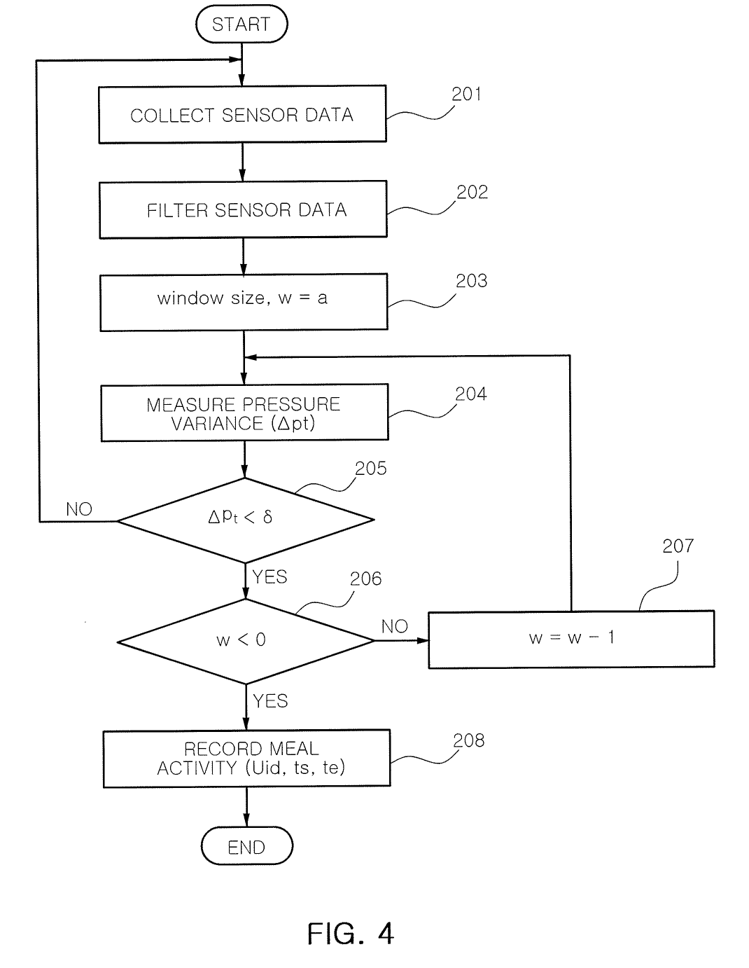

FIG. 4 illustrates a method of sensing a meal activity using pressure sensors in a meal activity sensing apparatus according to an exemplary embodiment of the present invention.

Referring to FIG. 4, the meal activity sensing apparatus collects sensor data from the pressure sensors installed in the smart meal mat 10 in operation 201, and then filters the collected sensor data in operation 202.

In operation 203, the meal activity sensing apparatus sets a window size w, which is a time interval to measure a pressure variance, as a first threshold value “a” that is preset by an experiment. Here, “a” is information per unit time. In case of 30 seconds window size, when the sensor data is filtered three times per second, its value is 90.

The meal activity sensing apparatus measures a pressure variance (Δpₜ=pₜ−pₜ_{_{—}}₁) between an earlier time (t−1) and a present time t in operation 204. Then, the measured pressure variance Δpₜ is compared with a preset second threshold value δ in operation 205, in order to determine whether the measured pressure variance Δpₜ is smaller than the second threshold value δ. As a result of the comparison, when the pressure variance is not smaller than the second threshold value δ, operation 201 is performed again. At this time, the pressure variance signifies the meal activity, that is, eating activities. The meal activity sensing apparatus collects subsequent data, and a subsequently measured pressure variance becomes (Δpₜ=pₜ₊₁−pₜ).

In contrast, when the pressure variance is smaller than the second threshold value δ, the meal activity sensing apparatus determines whether the window size w is smaller than zero in operation 206. As a result of the determination, when the window size w is not smaller than zero, the meal activity sensing apparatus reduces the value of the window size w by one (w=w−1) in operation 207, and then proceeds to operation 204 and measures a subsequent pressure variance. On the other hand, when the window size w is smaller than zero, the meal activity sensing apparatus determines that the meal activity has ceased, and records the meal activity, that is, records the meal activity information in the storage unit 150 in operation 208. Then, the operations are terminated.

As set forth above, according to exemplary embodiments of the invention, there is an advantage of more accurate detection of the meal activity by using the sensor data detected through the plurality of pressure sensors installed in the smart meal mat. Therefore, it can be useful in care services for eldercare facilities and for elderly individuals living alone, and further, in the efficient observance of an individual's daily meal patterns.

While the present invention has been shown and described in connection with the exemplary embodiments, it will be apparent to those skilled in the art that modifications and variations can be made without departing from the spirit and scope of the invention. Thus, it is intended that the invention covers the modifications and variations of the invention provided they come within the scope of the appended claims and their equivalents.

What is claimed is:

1. A method of sensing a meal activity using pressure sensors, the method comprising:
collecting sensor data from a plurality of pressure sensors installed in a smart meal mat;
measuring a pressure variance by using the collected sensor data;
determining whether a meal activity has taken place by comparing the measured pressure variance with a preset threshold value; and
transmitting meal activity information associated with the meal activity.

2. The method of claim 1, wherein the measuring of the pressure variance by using the collected sensor data comprises:
setting a window size for a time interval to measure the pressure variance; and
measuring a pressure variance between an earlier time and a present time within a range of the window size.

3. The method of claim 2, wherein the determining of whether the meal activity has taken place by comparing the measured pressure variance with the preset threshold value comprises:
determining whether the measured pressure variance is larger than the preset threshold value; and
determining that the meal activity has taken place when the measured pressure variance is larger than the preset threshold value.

4. The method of claim 3, wherein the determining of whether the meal activity has taken place by comparing the measured pressure variance with the preset threshold value further comprises:
determining whether the window size is smaller than zero when the measured pressure variance is smaller than the preset threshold value;
determining that the meal activity has ceased when the window size is smaller than zero; and
recording the meal activity information.

5. The method of claim 4, wherein the determining of whether the meal activity has taken place by comparing the measured pressure variance with the preset threshold value further comprises reducing a value of the window size by one in order to measure a subsequent pressure variance when the window size is larger than zero.

6. The method of claim 1, wherein the meal activity information comprises at least one of user information, meal start time, and meal end time.

7. A meal activity sensing apparatus using pressure sensors, the meal activity sensing apparatus comprising:
a sensor data collector collecting sensor data detected through a plurality of pressure sensors installed in a smart meal mat;
a controller measuring a pressure variance by using the collected sensor data and determining whether a meal activity has taken place by comparing the measured pressure variance with a preset threshold value; and
a data transmitter/receiver transmitting meal activity information associated with the meal activity to an information processor communicating with the smart meal mat via radio frequency.

8. The meal activity sensing apparatus of claim 7, further comprising a storage unit recording the meal activity information.

9. The meal activity sensing apparatus of claim 7, wherein the controller sets a window size for a time interval to measure the pressure variance, measures a pressure variance between an earlier time and a present time within a range of the window size, and determines whether the meal activity has taken place by comparing the measured pressure variance with a preset threshold value.

10. The meal activity sensing apparatus of claim 9, wherein the controller determines that the meal activity has taken place when the measured pressure variance is larger than the preset threshold value, and controls the sensor data collector to collect subsequent sensor data.

11. The meal activity sensing apparatus of claim 9, wherein the controller determines that the meal activity has ceased when the measured pressure variance is smaller than the preset threshold value and the window size is smaller than zero, and controls the meal activity information to be recorded.

12. The meal activity sensing apparatus of claim 9, wherein the controller reduces a value of the window size by one when the measured pressure variance is smaller than the preset threshold value and the window size is larger than zero, and measures a subsequent pressure variance by using subsequently filtered sensor data.
